(19) United States
(12) Patent Application Publication
(10) Pub. No.: US 2025/0355562 A1
(43) Pub. Date: Nov. 20, 2025

(54) METHOD AND DEVICE WITH PAGE MIGRATION OF TIERED MEMORY SYSTEM

(71) Applicants: Samsung Electronics Co., Ltd., Suwon-si (KR); Korea Advanced Institute of Science and Technology, Daejeon (KR)

(72) Inventors: Sungjoon PARK, Suwon-si (KR); Youngjin KWON, Daejeon (KR); ChangJun LEE, Daejeon (KR)

(73) Assignees: Samsung Electronics Co., Ltd., Suwon-si (KR); Korea Advanced Institute of Science and Technology, Daejeon (KR)

(21) Appl. No.: 19/206,631

(22) Filed: May 13, 2025

(30) Foreign Application Priority Data
May 14, 2024 (KR) 10-2024-0062962

(51) Int. Cl. G06F 3/06

(52) U.S. Cl. CPC G06F 3/0611; G06F 3/0647; G06F 3/0659; G06F 3/0673

(57) ABSTRACT

A page migration method performed by a processor including cores includes: reading, from a ring buffer, by a first core, samples of access events for memories connected with the cores; increasing, by the first core, an access count of a first page of a first memory among the memories based on the read samples of the access events; determining, by the first core, whether the first page is a hot page or a cold page based on the access count; generating, by the first core, a migration request to migrate the first page to a second memory among the memories depending on whether the first page is determined to be a hot page or a cold page; and performing, by a second core, migration of the first page from the first memory to the second memory based on the migration request.

### CROSS-REFERENCE TO RELATED APPLICATIONS

This application claims the benefit under 35 USC § 119 (a) of Korean Patent Application No. 10-2024-0062962, filed on May 14, 2024, in the Korean Intellectual Property Office, the entire disclosure of which is incorporated herein by reference for all purposes.

### BACKGROUND

### 1. Field

The following description relates to a method and device with page migration of a tiered memory system including one or more memories.

### 2. Description of Related Art

The demand for memory-intensive workloads such as artificial intelligence learning and big data analysis has been steadily increasing. To support these workloads, a tiered memory system including an additional memory other than a main memory may be used to expand total memory capacity.

The varying capacities and operation speeds of the memories in a tiered memory system may cause access delays. When a central processing unit accesses a relatively slow memory (e.g., random-access memory (RAM)) to find data, such as instructions not found in a fast memory (e.g., cache memory), additional delays may occur.

Various approaches have been devised to optimize memory allocation according to data access frequency to improve memory access delays in tiered memory systems. A method of scanning a page table or inducing a page fault to classify data according to access frequency may cause performance degradation in an application program, in a translation look-aside buffer (TLB) flush during bit initialization, or in overhead due to periodic page faults.

In a typical optimization method, as a control plane for determining the access frequency of data and a data plane for performing page migration are coupled to one thread. In this approach, performance degradation may occur in each plane in a limited cache memory capacity. An optimized memory allocation may improve the performance of a whole memory system and prevent cache invalidation during actual page migration and system monitoring, like the determining of the access frequency of data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a page migration method of a tiered memory system is performed by a processor including cores, and the page migration method includes: reading, from a ring buffer, by a first core among the cores, samples of access events for memories connected with the cores; increasing, by the first core, an access count of a first page of a first memory among the memories based on the read samples of the access events; determining, by the first core, whether the first page is a hot page or a cold page based on the access count; generating, by the first core, a migration request to migrate the first page to a second memory among the memories depending on whether the first page is determined to be a hot page or a cold page; and performing, by a second core among the cores, migration of the first page from the first memory to the second memory based on the migration request.

The method may further include: collecting, by a third core among the cores, the samples of the access events into the ring buffer by sampling the access events for the memories at regular intervals, wherein the samples of the access events include respective target virtual memory addresses for respectively corresponding access events.

The access count may be increased by one when a target virtual memory address included in one sample of the samples read from the ring buffer is a first virtual memory address of the first page mapped to a physical address of the first memory.

The determining whether the first page is a hot page or a cold page based on the access count may include: determining the first page as a hot page when the access count is greater than or equal to a set number.

The determining whether the first page is a hot page or a cold page based on the access count may include: determining the first page as a cold page when the access count is less than a set number.

The generating the migration request to migrate the first page to the second memory depending on whether the first page is a hot page or a cold page may include: determining whether the first memory is a slow memory when the first page is determined to be a hot page; and, when the first page is determined to be a slow memory, selecting the second memory as a target of the migration request based on the second memory having a faster operation speed than the first memory.

The generating the migration request to migrate the first page to the second memory when the second memory has a faster operation speed than the first memory may include: based on a free space of the second memory, identifying, by the first core, a cold page that is mapped to the second memory based on an access count, derived from the ring buffer, of a page mapped to the second memory; generating, by the first core, a migration request to migrate the cold page of the second memory to a third memory that has a slower operation speed than the second memory; performing, by the second core, migration of the cold page from the second memory to the third memory based on the migration request of the cold page; and generating, by the first core, the migration request to migrate the first page to the second memory.

The migration request to migrate the first page to the second memory depending on whether the first page is a hot page or a cold page includes is generated based on the second memory having a slower operation speed compared to the first memory.

The generating the migration request to migrate the first page to the second memory having a slower operation speed than the first memory when the first page is a fast memory may include: evaluating free space of the first memory when the first memory is a fast memory; and based on the evaluating, generating the migration request to migrate the first page to the second memory.

The performing the migration of the first page from the first memory to the second memory based on the migration request may include: un-mapping a physical memory address of the first memory mapped to a first virtual memory address of the first page; copying data of the first page to the second page through a direct memory access (DMA) engine; and mapping a physical memory address of the second memory to a second virtual memory address of the second page.

The access count of the first page may be stored as metadata of the first page.

The access events for the memories may be sampled through hardware-based event sampling.

The method may further include detecting a last level cache (LLC) miss event, and based on the detection of the LLC miss event, sampling the access events for the memories into the ring buffer.

A non-transitory computer-readable storage medium may store instructions that, when executed by a processor, cause the processor to perform any of the page migration methods.

In another general aspect, an electronic device includes: a processor including cores; and memories, one or more of memories storing instructions that, when executed by the processor individually or collectively, cause the electronic device to: through a first core among the cores, read, from a ring buffer, samples of access events for the memories, which are connected with the cores, through the first core, increase an access count of a first page of a first memory among the memories based on the read samples of the access events, through the first core, determine whether the first page is a hot page or a cold page based on the access count, through the first core, generate a migration request to migrate the first page to a second memory among the memories depending on whether the first page is determined to be a hot page or a cold page, and, through a second core among the plurality of cores, perform migration of the first page from the first memory to the second memory based on the migration request.

The instructions, when executed by the processor individually or collectively, further cause the electronic device to, through a third core among the cores, collect the samples of the respective access events into the ring buffer by sampling the access events for the memories at regular intervals, wherein the samples of the access events include respective target virtual memory addresses for respectively corresponding access events.

The determining whether the first page is a hot page or a cold page based on the access count may include: determining the first page as a hot page when the access count is greater than or equal to a set number.

The determining whether the first page is a hot page or a cold page based on the access count may include: determining the first page as a cold page when the access count is less than a set number.

The generating the migration request to migrate the first page to the second memory depending on whether the first page is a hot page or a cold page may include: determining whether the first memory is a slow memory when the first page is determined to be a hot page; and, when the first page is determined to be a slow memory, generating the migration request to migrate the first page to the second memory based on the second memory having a faster operation speed than the first memory.

The generating the migration request to migrate the first page to the second memory depending on whether the first page is a hot page or a cold page may include: determining whether the first memory is a fast memory when the first page is a cold page; and, when the first page is determined to be a fast memory, generating the migration request to migrate the first page to the second memory based on the second memory having a slower operation speed than the first memory.

Other features and aspects will be apparent from the following detailed description, the drawings, and the claims.

### BRIEF DESCRIPTION OF THE DRAWINGS

FIG. 1 illustrates an example of a tired memory system, according to one or more embodiments.

FIG. 2 illustrates an example of an electronic device, according to one or more embodiments.

FIG. 3 illustrates an example of a page migration method, according to one or more embodiments.

FIG. 4 illustrates an example of a decoupled control plane and data plane, according to one or more embodiments.

FIG. 5 illustrates an example of a method of generating a migration request, according to one or more embodiments.

FIG. 6 illustrates another example of a page migration method, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

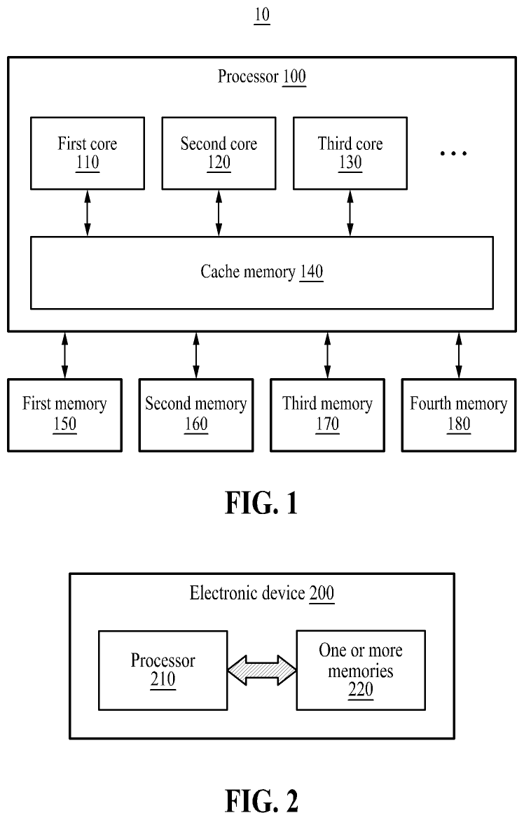

FIG. 1 illustrates an example of a tired memory system, according to one or more embodiments. As noted above, in the case of coupling a control plane for (determining the access frequency of data) and a data plane (for performing page migration) are coupled in one thread, when there is limited cache memory, degradation may occur in each plane. An optimized memory allocation may improve the performance of a whole memory system and prevent cache invalidation during actual page migration and system monitoring, such as the determining of the access frequency of data.

A tiered memory system (hereinafter, the system) 10 may include at least one processor (hereinafter, the processor) 100.

The system 10 may include one or more memories that it configures in a memory architecture using the heterogeneous power performance characteristics of respective tiers of the memory architecture. A tier of the system 10 may be determined mainly depending on an operation performance (e.g., speed and/or capacity) of the tier. For example, the system 10 may include a first memory 150, a second memory 160, a third memory 170, and a fourth memory 180, which have respective different operation performance (e.g., speed and/or capacity); the number and type of memories included in the system 10 is not limited to the examples of the present disclosure.

The processor 100 may include cores. For example, the processor 100 may include a first core 110, a second core 120, and a third core 130; the number of cores of the processor 100 is not limited to the examples described herein. The cores may be connected directly or indirectly to the one or more memories of the system 10.

Although not shown in FIG. 1, the processor 100 may include cache memories connected individually to/with the respective cores. For example, the processor 100 may include basic cache memories of level 1 (L1) and cache memories of level 2 (L2).

The processor 100 may include a single cache memory 140 that may be shared by all of its cores. For example, the processor 100 may include level 3 (L3) connected to all the of its cores as the cache memory 140. The cache memory 140 may also be called a shared cache memory.

The processor 100 may perform hardware-based event sampling. When a designated event occurs, the processor 100, may sample the designated event. For example, an event to be sampled may be designated by a user or by a system setting. The hardware-based event sampling has low overhead and is suitable for a large-capacity memory environment.

For example, the processor 100 may perform precision event-based sampling (PEBS). When an event designated through PEBS occurs, the processor 100, may sample the designated event.

The processor 100 may be preset to detect a last-level cache (LLC) miss event. For example, in the system 10, LLC may correspond to the cache memory 140 of L3, that is, the last level.

The LLC miss event may be a dynamic random-access memory (DRAM) LLC miss event that occurs when data is not found in the cache memory 140 and must be retrieved from a memory, like DRAM.

The LLC miss event may be, specifically, a remote LLC miss event that occurs when data is not found in the local cache memory 140 of a processor (e.g., the processor 100) in a multiprocessor system and must be retrieved from the LLC of a remote processor (i.e., other than the processor 100).

AN LLC miss event may occur when accessing a memory storing specific data.

When the LLC miss event occurs, the processor 100 may track and record a memory address of data where the miss event occurred through hardware-based components, such as a performance monitoring unit (PMU), or instructions and components based on various pieces of software for monitoring, profiling, or debugging. Based on the detection of the LLC miss event, the processor 100 may sample memory access events for the one or more memories in proximity to the LLC miss event.

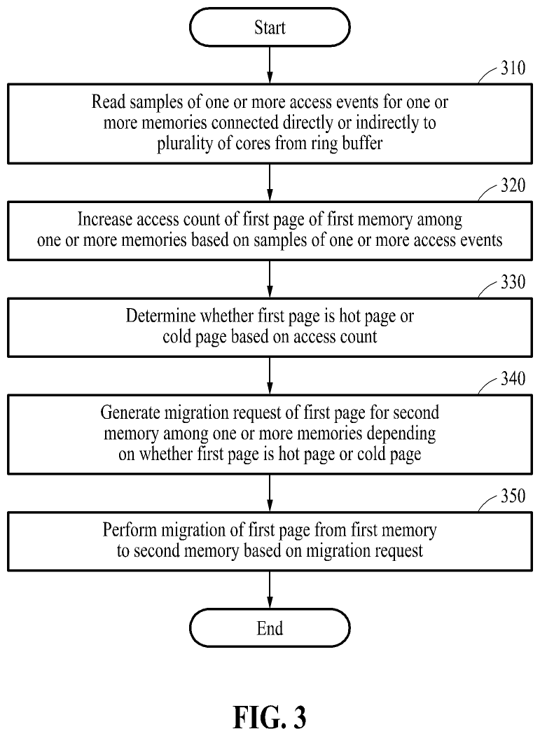

The processor 100 may collect the samples of the access events in a ring buffer. The ring buffer may be at least a portion of a memory area that is shared by user space and kernel space of the processor 100. Accordingly, artificially-forced page migration of the system 10 may be performed without a system call for a request or a command between the user space and the kernel space (i.e., without impetus from an actual memory access to data). The page migration method is described with reference to FIG. 3.

FIG. 2 illustrates an example of an electronic device, according to one or more embodiments.

According to one or more embodiments, an electronic device 200 may include at least one processor (hereinafter, the processor) 210 (e.g., the processor 100 of FIG. 1) and one or more memories 220 (e.g., the first through fourth memories 150-180) storing instructions. For example, the electronic device 200 may be the tiered memory system 10 described above with reference to FIG. 1 or a similar processing device. The processor 210 may include at least one processor including a processor circuit. When some of the instructions are executed individually or collectively by the processor 210, the electronic device 200 may be caused to perform at least some of the operations described with reference to FIGS. 1 to 6 of the present disclosure.

The electronic device 200 may include a communicator that is connected to the processor 210 and the one or more memories 220 and transmits or receives data to and from the processor 210 and the one or more memories 220. The communicator may be connected to another external device and may transmit and receive data to and from the external device. Hereinafter, transmitting and receiving “A” may refer to transmitting and receiving “information or data indicating A”.

The communicator may be implemented as circuitry in the electronic device 200. For example, the communicator may include an internal bus and an external bus. For another example, the communicator may be an element that connects the electronic device 200 to the external device. The communicator may be an interface (e.g., a bus interface, a network interface, etc.). The communicator may receive data from the external device and may transmit the data to the processor 210 and the one or more memories 220.

The processor 210 may process the data that has been received by the communicator and stored in the one or more memories 220. A “processor” described herein may be a hardware-implemented data processing device having a circuit configured to execute desired operations. For example, the desired operations may include code or instructions included in a program. For example, the processor, or hardware-implemented data processing device, may be/include a microprocessor, a central processing unit (CPU), a graphics processing unit (GPU), a processor core, a multi-core processor, a multiprocessor, an application-specific integrated circuit (ASIC), or a field-programmable gate array (FPGA).

The processor 210 may control other components of the electronic device 200 (e.g., hardware or software components) and may perform various types of data processing or operations. As at least a part of data processing or operations, the processor 210 may store instructions or data received from another component (e.g., the communicator) in the one or more memories 220, may process the instructions or data stored in the one or more memories 220, and may store result data in the one or more memories 220. The operations performed by the processor 210 may be substantially the same as the operations of the electronic device 200.

The one or more memories 220 may store information necessary for the processor 210 to perform a processing operation. The one or more memories 220 (or one or more storage media included in the one or more memories 220) may store instructions to be executed by the processor 210 and may store related information while software or a program is executed in the electronic device 200. For example, the one or more memories 220 may include one or more memories, which are volatile and/or non-volatile memories known in the field, like RAM, DRAM, static RAM (SRAM), non-volatile RAM (NVRAM), persistent memory (PMEM), magneto-resistive RAM (MRAM), high bandwidth memory (HBM), or 3DXPoint, as non-limiting examples.

The electronic device 200 may be connected to an external memory through the communicator. For example, the external memory may include one or more volatile memories, non-volatile memories and RAM, flash memories, hard disk drives, and optical disc drives. The external memory may store an instruction set (e.g., software) for operating the electronic device 200. The instruction set for operating the electronic device 200 may be executed by the processor 210.

FIG. 3 illustrates an example of a page migration method, according to one or more embodiments.

According to an embodiment, operations 310 to 350 may be performed by an electronic device (e.g., the electronic device 200 of FIG. 2). For example, the electronic device may include at least one processor (e.g., the processor 100 of FIG. 1 or the processor 210 of FIG. 2) and one or more memories (e.g., the first memory 150, the second memory 160, the third memory 170, and the fourth memory 180 of FIG. 1 or the one or more memories 220 of FIG. 2).

In the tiered memory system 10 of FIG. 1, the memory at each tier may share a virtual address space through a virtual memory technique.

The virtual address space may be a logical space given on a per-process basis (each process may be provided with its own virtual address space). The virtual address space may be implemented in units of pages each having a same page size.

A physical address space effective in the actual memory of the tiered memory system 10 may include a frame unit having, for example, the same size as the size of a page.

One process may have one page table. The page table may store the page information of a process. As a frame of the physical address space is allocated to a page, the page may be positioned in a physical memory. The page table may include a page number (index) in the virtual address space and a start address (or a most significant bit) of the physical memory allocated to the page. A physical memory address of a frame mapped to a page may be a combination/concatenation of a corresponding virtual memory address and a corresponding start address of a physical memory.

The electronic device may sample one or more memory access events for the one or more memories through any of the hardware-based event sampling techniques described above with reference to FIG. 1. The electronic device may collect samples of the one or more access events in a ring buffer by sampling the one or more access events for the one or more memories at regular intervals.

The samples of the one or more access events may each include a target virtual memory address for a corresponding access event. In other words, the samples may include a target virtual memory address in the virtual address space of a page where each sampled access event has occurred.

In operation 310, the electronic device may read the samples of the one or more access events for the one or more memories connected directly or indirectly to a plurality of cores from the ring buffer. Operation 310 may be performed repeatedly.

The electronic device may perform operation 310 in a constant cycle. In other words, the electronic device may read the samples from the ring buffer at regular intervals.

In operation 320, the electronic device may increase an access count of a first page of a first memory (e.g., the first memory 150 of FIG. 1) (one of the one or more memories) based on the samples in the ring buffer. A physical memory address of the first memory may be pre-mapped to a first virtual memory address of the first page in the virtual address space.

Note that in the following description, the term “first” in the phrase “first page” and the term “second” in the phrase “second page” are each used to distinguish between types of pages (e.g., hot (first) pages and cold (second) pages), rather than specific instances of pages.

The electronic device may increase an access count of a page in the virtual address space based on the target virtual memory addresses for the corresponding access events included in the samples of the one or more access events. Specifically, the electronic device may increase the access count of the first page by one when a target virtual memory address included in a sample read from the ring buffer is the first virtual memory address of the first page mapped to the physical memory address of the first memory.

The electronic device may store the access count of the first page as metadata of the first page.

The access count of a page in the virtual address space may be increased where an access event has occurred, based on each of the samples read from the ring buffer. Accordingly, the access count of a page where multiple access events have occurred may increase by the number of the access events. The electronic device may store the access count of each page in the virtual address space as metadata of the page.

In operation 330, the electronic device may determine whether the first page is a hot page or a cold page based on the access count.

A page having a high access event occurrence frequency (e.g., above a threshold amount or ratio) in the virtual space may be referred to as a hot page. The hot page may be understood as a page storing frequently accessed data (i.e., hot data).

A page having a low access event occurrence frequency in the virtual space may be referred to as a cold page. The cold page may be understood as a page storing infrequently accessed data (i.e., cold data).

The access count of the first page (as obtained from its metadata) may be compared with a set number (threshold) that is a reference for determining a hot page and a cold page.

The electronic device may determine the first page as a hot page when the access count of the first page is greater than or equal to the set number, and may determine the first page as a cold page when the access count of the first page is less than the set number.

The set number for determining a hot page and a cold page may be predetermined. The set number for determining a hot page and a cold page may be changed.

The set number of the access count that is a reference for determining a hot page and a cold page may be the same or different. That is, there may be a hot reference/threshold for identifying hot pages (those pages with access counts above the hot reference/threshold), and there may be a cold reference/threshold for identifying cold pages (those pages with access counts below the cold reference/threshold).

In operation 340, depending on whether the first page is a hot page or a cold page, the electronic device may generate a migration request for migrating the first page to a second memory (e.g., the second memory 160 of FIG. 1) among the memories of the memory system of the electronic device.

In some cases, the second memory targeted by the migration request may be a memory that operates faster than the first memory. When the first page is a hot page, the electronic device may generate the migration request of the first page to target the second memory based on the second memory having a faster operation speed compared to the first memory.

In some cases, the second memory may be a memory targeted by the migration request that operates slower than the first memory. When the first page is a cold page, the electronic device may generate the migration request of the first page to target the second memory based on the second memory having a slower operation speed compared to the first memory.

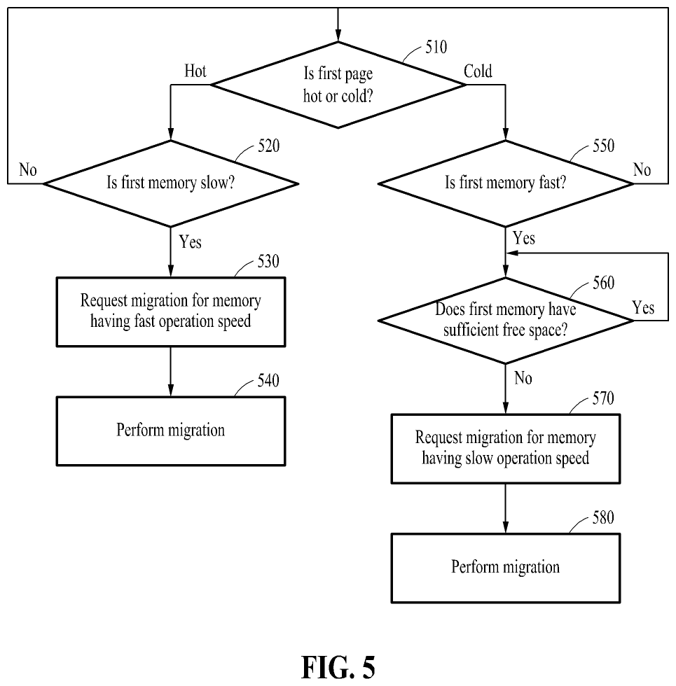

The method of generating a migration request is described with reference to FIG. 5.

In operation 350, the electronic device may perform the migration of the first page from the first memory to the second memory based on the migration request.

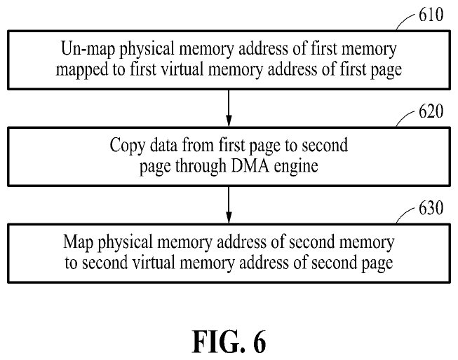

The page migration method is described in detail below with reference to FIG. 6.

Referring to FIG. 3, the electronic device may perform operations 310 to 350. Specifically, the electronic device may perform operations 310 to 350 by a processor including cores. Each of at least some of cores may perform operations 310 to 350. As described below, when instructions stored in the electronic device are executed by each core, the instructions cause each operation to be implemented in the electronic device.

A first core (e.g., the first core 110 of FIG. 1) may read the samples of the access events for the one or more memories connected directly or indirectly to the cores from the ring buffer (in operation 310).

The first core may increase the access count of the first page of the first memory among the one or more memories based on the samples of the access events (in operation 320).

The first core may determine whether the first page is a hot page or a cold page based on the first page's access count (in operation 330).

The first core may generate the migration request of the first page for the second memory among the one or more memories depending on whether the first page is a hot page or a cold page (in operation 340).

A second core (e.g., the second core 120 of FIG. 1) may perform the migration of the first page from the first memory to the second memory based on the migration request (in operation 350).

As described above, operations 310 to 340 various of monitoring the state of the tiered memory system 10, requesting page migration, and performing the page migration (operation 350) may be distributed among different cores of the processor.

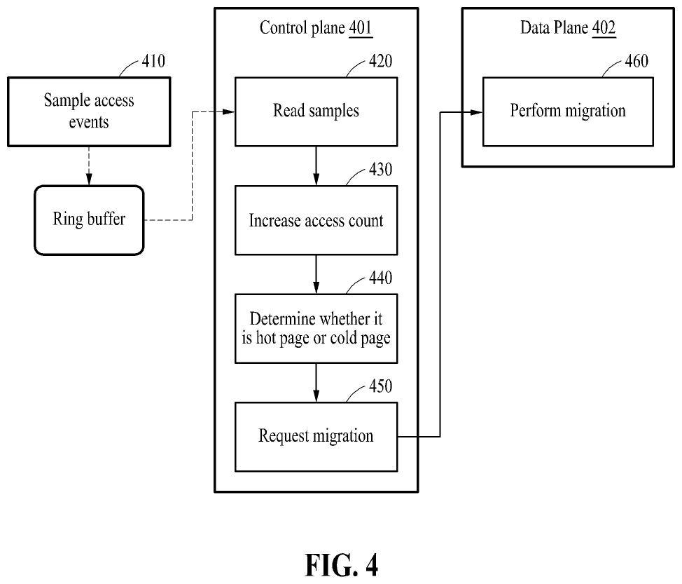

FIG. 4 illustrates an example of a decoupled control plane and data plane, according to one or more embodiments.

FIG. 4 illustrates characteristics of operation of the tiered memory system 10 described with reference to FIG. 1. The tiered memory system 10 may include a control plane 401 and a data plane 402.

In the tiered memory system 10, various portions of the operations described with reference to FIG. 3 may be performed as functions of the control plane 401 and the data plane 402.

Generally, a control plane 401 and a data 402 plane may be coupled such that the same core executes the functions of the control plane 401 and the data plane 402. When the control plane 401 is coupled to the data plane 402, the control plane 401 and the data plane 402 share L1, L2, and L3 cache memories connected to the same core. In this case, cache invalidation, in which the control plane 401 and the data plane 402 invalidate each other's data, may occur due to the limited capacity of the cache memories. Accordingly, the performance of the control plane 401 and the data plane 402 may be deteriorated.

As described herein, the tiered memory system 10 may be implemented by decoupling or separating the control plane 401 from the data plane 402. The functions of the control plane 401 and the data plane 402 may be executed by different cores of a processor.

The tiered memory system 10, by processing the control plane 401 and the data plane 402 as individual threads of different cores, may prevent cache invalidation performed by each plane on the other and improve cache locality.

Among the cores, the first core (e.g., the first core 110 of FIG. 1) described with reference to FIG. 3 may be used as the control plane 401. The first core may execute the functions of the control plane 401. The first core may determine the access frequency of data (or a page where the data is stored) and may request migration.

Among the cores, the second core (e.g., the second core 120 of FIG. 1) described with reference to FIG. 3 may be used as the data plane 402. The second core may execute the functions of the data plane 402. The second core may perform page migration based on the migration request.

According to an embodiment, operations 410 to 460 may be performed by an electronic device (e.g., the electronic device 200 of FIG. 2). For example, the electronic device may include at least one processor (e.g., the processor 100 of FIG. 1 or the processor 210 of FIG. 2) and one or more memories (e.g., the first memory 150, the second memory 160, the third memory 170, and the fourth memory 180 of FIG. 1 or the one or more memories 220 of FIG. 2). The electronic device may perform operations 410 to 460 by the processor including the plurality of cores. Each of at least some cores of the processor may perform operations 410 to 460. As described below, when instructions stored in the electronic device are executed by each core, the instructions cause each operation to be implemented in the electronic device.

A third core (e.g., the third core 130 of FIG. 1) may collect samples of access events into a ring buffer by sampling the access events for memories at regular intervals (in operation 410). The third core may sample the access events for the memories through the hardware-based event sampling described above with reference to FIG. 1. The samples of the access events in the ring buffer may each include a target virtual memory address for a corresponding access event.

Next, operations of the first core that executes the functions of the control plane 401 are described.

The first core may read the samples of the access events from the ring buffer (in operation 420).

The first core may increase an access count of a first page of a first memory among the one or more memories based on the samples of the access events (in operation 430).

The first core may determine whether the first page is a hot page or a cold page based on the first page's access count (in operation 440).

The first core may determine/flag the first page as a hot page when its access count is greater than or equal to a set number.

The first core may determine/flag the first page as a cold page when its access count is less than the set number.

The first core may generate a migration request of the first page for a second memory (among the memories) depending on whether the first page is has been flagged as a hot page or a cold page (in operation 450).

When the first page is a hot page, the first core may generate the migration request of the first page for targeting the second memory that has a faster operation speed than the first memory.

When the first page is a cold page, the first core may generate the migration request of the first page for targeting the second memory that has a slower operation speed compared to the first memory.

Next, the operation of the second core that executes the functions of the data plane 402 is described.

The second core may perform the migration of the first page from the first memory to the second memory based on the migration request (in operation 460).

The second core may move the data of the first page to a second page through a direct memory access (DMA) engine (or a DMA circuit). The second core may transmit (or copy) data through the DMA engine without having to pass the data through the processor. The page migration method is described with reference to FIG. 6.

FIG. 5 illustrates an example of a method of generating a migration request, according to one or more embodiments.

According to one or more embodiments, operations 510 to 580 may be performed by an electronic device (e.g., the electronic device 200 of FIG. 2). For example, the electronic device may include at least one processor (e.g., the processor 100 of FIG. 1 or the processor 210 of FIG. 2) and one or more memories (e.g., the first memory 150, the second memory 160, the third memory 170, and the fourth memory 180 of FIG. 1 or the one or more memories 220 of FIG. 2).

FIG. 5 illustrates a method of generating a migration request of the control plane 401.

Operation 330 of FIG. 3 and operation 440 of FIG. 4 for determining whether a first page is a hot page or a cold page generally correspond to operation 510.

In operation 510, the electronic device may determine whether the first page is a hot page or a cold page based on an access count of the first page.

The access count of the first page may be compared with a set number that is a reference for determining a hot page and a cold page, based on the metadata of the first page.

The electronic device may determine the first page as a hot page when the access count of the first page is greater than or equal to the set number.

The electronic device may determine the first page as a cold page when the access count of the first page is less than the set number.

The set number for determining a hot page and a cold page may be predetermined. The set number for determining a hot page and a cold page may be changed.

The set number of the access count that is a reference for determining a hot page and a cold page may be the same for hot and cold pages or there may be a different reference for each.

Next, the case where the first page is a hot page is described.

In operation 510, the electronic device may determine the first page as a hot page when the access count of the first page is greater than or equal to the set number.

In operation 520, when the first page is a hot page, the electronic device may determine whether a first memory (e.g., the first memory 150 of FIG. 1) where the first page is positioned is categorized as a slow memory (or may determine a speed of the first memory). In other words, the electronic device may determine whether the first memory whose physical memory address is mapped to a first virtual memory address of the first page is a slow memory. When the first page is a hot page with a high access frequency and the first memory is a slow memory, the positioning of the first page in a memory with a rapid operation speed may increase system efficiency.

The electronic device may determine whether there is a memory that is faster than the first memory in the tiered memory system 10.

When there is a memory that is faster than the first memory in the tiered memory system 10, the electronic device may determine the first memory as a slow memory.

In operation 530, when the first memory is a slow memory, the electronic device may generate a migration request for migrating the first page to a second memory (e.g., the second memory 160 of FIG. 1) having a faster operation speed compared to the first memory.

The electronic device may determine whether the second memory having a faster operation speed compared to the first memory whether the second memory has sufficient free space, and when the second memory has a faster operation speed and also has sufficient free space, the electronic device may generate the migration request of the first page for the second memory. When the second memory having a faster operation speed (compared to the first memory) does not have sufficient free space, the electronic device may identify a cold page that is mapped to the second memory based on an access count of a page mapped to the second memory (the second memory having been identified as a target for migration). For example, the electronic device may identify a page with the lowest access count among pages mapped to the second memory as a cold page.

The electronic device may generate a migration request to migrate a cold page of the second memory to a third memory (e.g., the third memory 170 of FIG. 1) having a slower operation speed than the second memory.

The electronic device may perform the migration of the cold page from the second memory to the third memory based on the migration request of the cold page. In sum, the electronic device may move cold data positioned in the second memory to the third memory.

When there are multiple memories having a faster operation speed compared to the first memory, the electronic device may generate the migration request of the first page to target a memory among the multiple faster memories. For example, the electronic device may generate a migration request for a memory with a fastest operation speed among the memories. For example, the electronic device may generate a migration request targeting a memory with sufficient free space among the memories.

In operation 540, and after any necessary migration of a cold page from the second memory, the electronic device may perform the migration of the first page from the first memory to the second memory based on the migration request of the first page. The page migration method is described with reference to FIG. 6.

Next, the case where the first page is a cold page is described.

In operation 510, the electronic device may determine/flag the first page as a cold page when the access count of the first page is less than the set number.

In operation 550, the electronic device may determine whether the first memory to which the first page is mapped is a fast memory. In other words, the electronic device may determine whether the first memory whose physical memory address is allocated to the first virtual memory address of the first page is a fast memory.

The electronic device may determine whether there is a memory that is slower than the first memory in the tiered memory system 10.

When there is a memory that is slower than the first memory in the tiered memory system 10, the electronic device may determine the first memory as a fast memory.

In operation 560, when the first memory is a fast memory, the electronic device may determine whether the first memory has sufficient free space. When the first page is a cold page with a low access frequency and is positioned in a fast memory without sufficient free space, system efficiency may be improved by moving the data of the first page into a memory with a relatively low operating speed (thus freeing up some of the faster first memory and increasing utilization thereof).

In operation 570, when the first memory does not have sufficient free space, the electronic device may generate the migration request to migrate the first page to the second memory having a slower operation speed compared to the first memory.

In operation 580, the electronic device may perform the migration of the first page from the first memory to the second memory based on the migration request of the first page. The page migration method is described in detail below with reference to FIG. 6.

The electronic device may perform operations 510 to 580 repeatedly at regular intervals.

FIG. 6 illustrates another example of a page migration method, according to one or more embodiments.

According to one or more embodiments, operations 610 to 630 may be performed by an electronic device (e.g., the electronic device 200 of FIG. 2). For example, the electronic device may include at least one processor (e.g., the processor 100 of FIG. 1 or the processor 210 of FIG. 2) and one or more memories (e.g., the first memory 150, the second memory 160, the third memory 170, and the fourth memory 180 of FIG. 1 or the one or more memories 220 of FIG. 2).

FIG. 6 illustrates a method of performing the migration of the data plane 402.

Operations 610 to 630 may be used in each of: operation 350 of performing page migration in FIG. 3; operation 460 of performing page migration in FIG. 4; and operations 540 and 580 of performing page migration in FIG. 5.

In operation 610, the electronic device may un-map a physical memory address of a first memory mapped to a first virtual memory address of a first page.

The electronic device may include a memory management unit (MMU) (or a memory management circuit) that controls memory access by a processor and manages a cache memory. The processor may transmit a virtual memory address in a virtual address space to the MMU. The MMU translates the virtual memory address into a physical memory address by referring to a page table.

The MMU refers to a translation lookaside buffer (TLB), that is, a high-speed backup memory, for dereferencing a virtual memory address, that is, for conversion between a virtual memory address and a physical memory address. The TLB stores the conversion/translation information of a recently referred page.

If the MMU is able to find desired conversion information in the TLB, the MMU may convert a virtual memory address to a physical memory address by using the conversion information therefrom.

If the MMU is unable to find the desired conversion information in the TLB, the MMU may convert a virtual memory address to a physical memory address by referring to the page table.

The electronic device may obtain the physical memory address of the first memory mapped to the first virtual memory address of the first page through the MMU. The operating system (OS) of the electronic device may eventually remove the mapping between the first virtual memory address and the physical memory address of the first memory.

In operation 620, the electronic device may copy data from the first page to a second page through a DMA engine (or a DMA circuit).

The processor, one or more memories, and DMA engine of the electronic device may be connected to one another through a bus line. The electronic device may move data between the one or more memories through the DMA engine.

The electronic device may transmit (or copy) data without having to pass the processor through the DMA engine. By moving data directly through the DMA engine, the number of interrupts may be minimized, and processor efficiency may be improved compared to the case where the processor directly reads data from a memory and transmits the thus-read data to another memory.

In operation 630, the electronic device may map a physical memory address of a second memory to a second virtual memory address of a second page.

The OS of the electronic device may map the physical memory address of the second memory to the second virtual memory address.

At least some of operations 610 to 630 may be performed by the processor, which includes cores. Any of the cores of the processor may perform at least some of operations 610 to 630. As described below, when instructions stored in the electronic device are executed by a core, the instructions cause each operation to be implemented in the electronic device.

A second core (e.g., the second core 120 of FIG. 1) among the cores may un-map the physical memory address of the first memory mapped to the first virtual memory address of the first page (in operation 610).

The second core may obtain the physical memory address of the first memory mapped to the first virtual memory address of the first page through the MMU. The second core may request the OS to remove the mapping between the first virtual memory address and the physical memory address of the first memory. In response, the OS of the electronic device may remove the mapping between the first virtual memory address and the physical memory address of the first memory.

The second core may request the DMA engine to copy data from the first page to the second page. Specifically, the second core may transmit information, such as the source memory address of the data to be copied, a destination memory address, and the size of the data to be copied, to the DMA engine. The second core may transmit the first virtual memory address of the first page as the source memory address, the second virtual memory address of the second page as the destination memory address, and the size of data to the DMA engine. In response, the DMA engine may copy data from the first page to the second page (in operation 620).

To remap the moved data, the second core may map the physical memory address of the second memory to the second virtual memory address of the second page (in operation 630).

The second core may request the OS for the mapping between the second virtual memory address and the physical memory address of the second memory. The OS may map the physical memory address of the second memory to the second virtual memory address.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a FPGA, a programmable logic unit (PLU), a microprocessor, or any other device capable of responding to and executing instructions in a defined manner. The processing device may run an OS and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The computing apparatuses, the electronic devices, the processors, the memories, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A page migration method of a tiered memory system performed by a processor comprising cores, the page migration method comprising:
reading, from a ring buffer, by a first core among the cores, samples of access events for memories connected with the cores;
increasing, by the first core, an access count of a first page of a first memory among the memories based on the read samples of the access events;
determining, by the first core, whether the first page is a hot page or a cold page based on the access count;
generating, by the first core, a migration request to migrate the first page to a second memory among the memories depending on whether the first page is determined to be a hot page or a cold page; and
performing, by a second core among the cores, migration of the first page from the first memory to the second memory based on the migration request.

2. The page migration method of claim 1, further comprising:
collecting, by a third core among the cores, the samples of the access events into the ring buffer by sampling the access events for the memories at regular intervals,
wherein the samples of the access events comprise respective target virtual memory addresses for respectively corresponding access events.

3. The page migration method of claim 2, wherein the access count is increased by one when a target virtual memory address comprised in one sample of the samples read from the ring buffer is a first virtual memory address of the first page mapped to a physical address of the first memory.

4. The page migration method of claim 1, wherein the determining whether the first page is a hot page or a cold page based on the access count comprises:
determining the first page as a hot page when the access count is greater than or equal to a set number.

5. The page migration method of claim 1, wherein the determining whether the first page is a hot page or a cold page based on the access count comprises:
determining the first page as a cold page when the access count is less than a set number.

6. The page migration method of claim 1, wherein the generating the migration request to migrate the first page to the second memory depending on whether the first page is a hot page or a cold page comprises:
determining whether the first memory is a slow memory when the first page is determined to be a hot page; and,
when the first page is determined to be a slow memory, selecting the second memory as a target of the migration request based on the second memory having a faster operation speed than the first memory.

7. The page migration method of claim 6, wherein the generating the migration request to migrate the first page to the second memory when the second memory has a faster operation speed than the first memory comprises:
based on a free space of the second memory, identifying, by the first core, a cold page that is mapped to the second memory based on an access count, derived from the ring buffer, of a page mapped to the second memory;
generating, by the first core, a migration request to migrate the cold page of the second memory to a third memory that has a slower operation speed than the second memory;
performing, by the second core, migration of the cold page from the second memory to the third memory based on the migration request of the cold page; and
generating, by the first core, the migration request to migrate the first page to the second memory.

8. The page migration method of claim 1, wherein the migration request to migrate the first page to the second memory depending on whether the first page is a hot page or a cold page comprises is generated based on the second memory having a slower operation speed compared to the first memory.

9. The page migration method of claim 8, wherein the generating the migration request to migrate the first page to the second memory having a slower operation speed than the first memory when the first page is a fast memory comprises:
evaluating free space of the first memory when the first memory is a fast memory; and
based on the evaluating, generating the migration request to migrate the first page to the second memory.

10. The page migration method of claim 1, wherein the performing the migration of the first page from the first memory to the second memory based on the migration request comprises:
un-mapping a physical memory address of the first memory mapped to a first virtual memory address of the first page;
copying data of the first page to the second page through a direct memory access (DMA) engine; and
mapping a physical memory address of the second memory to a second virtual memory address of the second page.

11. The page migration method of claim 1, wherein the access count of the first page is stored as metadata of the first page.

12. The page migration method of claim 1, wherein the access events for the memories are sampled through hardware-based event sampling.

13. The page migration method of claim 1, further comprising detecting a last level cache (LLC) miss event, and based on the detection of the LLC miss event, sampling the access events for the memories into the ring buffer.

14. A non-transitory computer-readable storage medium storing instructions that, when executed by a processor, cause the processor to perform the page migration method of claim 1.

15. An electronic device comprising:
a processor comprising cores; and
memories, one or more of the memories storing instructions that, when executed by the processor individually or collectively, cause the electronic device to:
through a first core among the cores, read, from a ring buffer, samples of access events for the memories, which are connected with the cores,
through the first core, increase an access count of a first page of a first memory among the memories based on the read samples of the access events,
through the first core, determine whether the first page is a hot page or a cold page based on the access count,
through the first core, generate a migration request to migrate the first page to a second memory among the memories depending on whether the first page is determined to be a hot page or a cold page, and,
through a second core among the plurality of cores, perform migration of the first page from the first memory to the second memory based on the migration request.

16. The electronic device of claim 15, wherein the instructions, when executed by the processor individually or collectively, further cause the electronic device to,
through a third core among the cores, collect the samples of the respective access events into the ring buffer by sampling the access events for the memories at regular intervals,
wherein the samples of the access events comprise respective target virtual memory addresses for respectively corresponding access events.

17. The electronic device of claim 15, wherein the determining whether the first page is a hot page or a cold page based on the access count comprises:
determining the first page as a hot page when the access count is greater than or equal to a set number.

18. The electronic device of claim 15, wherein the determining whether the first page is a hot page or a cold page based on the access count comprises:
determining the first page as a cold page when the access count is less than a set number.

19. The electronic device of claim 15, wherein the generating the migration request to migrate the first page to the second memory depending on whether the first page is a hot page or a cold page comprises:
determining whether the first memory is a slow memory when the first page is determined to be a hot page; and,
when the first page is determined to be a slow memory, generating the migration request to migrate the first page to the second memory based on the second memory having a faster operation speed than the first memory.

20. The electronic device of claim 15, wherein the generating the migration request to migrate the first page to the second memory depending on whether the first page is a hot page or a cold page comprises:
determining whether the first memory is a fast memory when the first page is a cold page; and,
when the first page is determined to be a fast memory, generating the migration request to migrate the first page to the second memory based on the second memory having a slower operation speed than the first memory.
